(19) United States
(12) Patent Application Publication
(10) Pub. No.: US 2026/0259649 A1
(43) Pub. Date: Sep. 3, 2026

(54) METHOD AND SYSTEM FOR OVERLAYING SECURITY CONTEXT IN CONVERSATIONAL USER INTERFACES

(71) Applicant: Straiker Inc., San Jose, CA (US)

(72) Inventors: Lawrence St. John, Pella, IA (US); Johnathan Cyril Ludwig, Wesley Chapel, FL (US); Girishkumar Chandrasekar, San Francisco, CA (US)

(21) Appl. No.: 19/437,935

(22) Filed: Dec. 31, 2025

Related U.S. Application Data
(60) Provisional application No. 63/765,153, filed on Feb. 28, 2025.

(51) Int. Cl. G06F 3/04845; G06F 9/451

(52) U.S. Cl. CPC G06F 3/04845; G06F 9/451

(57) ABSTRACT

Methods and systems for context-aware security overlays for conversational user interfaces are provided. User-provided data is detected at one or more input fields of a user interface of a client device associated with a first user. The input field(s) are associated with an operation of a computing system that generates a response to the user-provided data. A determination is made that a data item of the user-provided data and/or the generated response satisfies one or more data security criteria. The UI is updated to include one or more security UI elements indicating that the data item satisfies the data sensitivity criteria. Responsive to a detection of a user interaction with the one or more security UI elements by a second user, the response to the user-provided data is modified. The modified response is provided to the user-provided data for presentation via the client device associated with the first user.

### RELATED APPLICATIONS

This non-provisional application claims priority to U.S. Provisional Patent Application 63/765,153 entitled “Method and System for Overlaying Security Context in Conversational User Interfaces, filed Feb. 28, 2025, the contents of which are entirely incorporated by reference.

### TECHNICAL FIELD

Aspects and implementations of the present disclosure relate to methods and systems for context-aware security overlays for conversational user interfaces.

### BACKGROUND

Turn-based communication has become widespread in digital communication platforms, including chat-based messaging systems, voice assistants, customer service chatbots, and enterprise collaboration tools. Users can engage with other users or automated systems of such platforms via conversational user interfaces (UIs) through which user-provided data (e.g., text, audio signals, etc.) is processed in real-time by backend systems to facilitate interactive communication between users and automated systems or other users. As turn-based communication functionalities are increasingly deployed in sensitive environments such as banking, healthcare, and enterprise workflows, the handling of sensitive data within these interfaces presents technical challenges. Existing security approaches generally focus on backend encryption and access control mechanisms that operate independently of the user interface layer. However, these conventional security measures do not provide real-time detection and visualization of sensitive information at the interface level, leaving users without immediate awareness of potential data exposure risks during text input and submission processes. The lack of integrated security context within the conversational interface itself can result in inadvertent transmission of sensitive data such as personally identifiable information, financial data, or confidential business information through communication channels.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 is a block diagram of an example security engine 152, in accordance with implementations of the present disclosure.

FIG. 3 is a block diagram of an example method for context-aware security overlays for conversational user interfaces, in accordance with implementations of the present disclosure.

FIGS. 4A-4D illustrate example user interfaces associated with the context-aware security overlays, in accordance with implementations of the present disclosure.

FIG. 5 illustrates an example predictive system, in accordance with implementations of the present disclosure.

FIG. 6 is a block diagram illustrating an exemplary computer system, in accordance with implementations of the present disclosure.DETAILED DESCRIPTION

### DETAILED DESCRIPTION

Aspects of the present disclosure relate to methods and systems for context-aware security overlays for conversational user interfaces. Turn-based communication has become a fundamental component of modern digital communication systems, enabling users to interact with software applications, automated systems, and other users through natural language exchanges. Such communication systems enable users to communicate via conversational interfaces, which serve as an interactive layer through which users access underlying system functionality, including text-based messaging tools, voice-driven assistants that provide textual or auditory responses, customer service chatbots, enterprise communication tools, artificial intelligence (AI)-driven messaging systems, and so forth. Users can provide data or information via a conversational interface associated with a system, which can be processed in real-time (or approximately real-time) by the system to generate contextually appropriate responses, which facilitates bidirectional communication between users and automated systems or between multiple users through the computing system. Tools and functionalities associated with such communication systems are increasingly being integrated into sensitive environments such as healthcare portals, legal consultation services, banking platforms, enterprise workflow management tools, etc. In these contexts, users routinely input and transmit data through conversational exchanges, including personal information, financial details, medical records, authentication credentials, confidential business information, and so forth. The conversational nature of these interfaces encourages fluid, natural communication, which can lead users to share information in ways that mirror informal human conversation rather than structured data entry through traditional forms. Additionally, AI-driven systems that generate responses to user queries may produce outputs containing sensitive information that involves oversight before being delivered to end users.

Conventional security approaches for protecting sensitive data in digital systems focus primarily on backend mechanisms such as encryption during transmission, access control policies enforced at the server level, and post-transmission data handling protocols. These security measures operate independently of the user interface layer, providing no real-time feedback or contextual awareness to users as they compose and prepare to submit their messages or queries. Users interacting with conversational interfaces typically receive no immediate indication that the text they are typing contains sensitive information that may pose data exposure risks. Similarly, security professionals responsible for monitoring AI interactions lack integrated tools to review and intervene on AI-generated responses before they reach end users. Traditional security warnings, when they exist at all, tend to appear as generic alerts or pop-up notifications that interrupt the conversational flow and provide limited context about the specific nature of the security concern. Furthermore, existing systems do not provide security professionals with granular control over how sensitive information in AI-generated responses is handled before delivery to end users, instead relying on predetermined backend policies that apply uniformly regardless of the specific context of the conversation, the role of the user, or the sensitivity level of the particular data being shared. The disconnect between the user interface layer where data is created and responses are generated, and the security layer where data is protected creates a gap in security oversight and control.

This lack of integrated security context at the interface level leads to several technical and operational problems that significantly impact computing system performance. Users may inadvertently transmit sensitive data through communication channels without awareness of the potential security implications, and AI systems may generate responses containing sensitive information that is delivered to end users without appropriate security review, leading to unintended data exposure incidents that could violate organizational policies or regulatory compliance constraints. The absence of real-time detection and visualization of sensitive information in both user inputs and AI-generated responses leads to the identification of security issues only after data has been submitted and processed by backend systems, at which point the data may have already been logged, transmitted to third parties, or stored in systems with broader access permissions than appropriate for the sensitivity level of the information. This reactive approach to security increases the burden on security systems that monitor, audit, and remediate data exposure incidents after they occur rather than preventing them at the source, which can involve additional computational processes that consume significant computing resources and degrade system efficiency. For example, when the system detects a sensitive data exposure post-transmission, the system performs resource-intensive remediation operations including data quarantine procedures, access log analysis, notification system activation, and/or rollback operations that can impact system latency and throughput. The lack of security professional-facing controls for monitoring and intervening on AI generated response also reduces organizational confidence in conversational systems deployed in sensitive environments, as security teams have no visibility into how their AI responses are being classified or protected before delivery. From a compliance perspective, organizations face challenges in demonstrating that appropriate safeguards were in place at the point of response delivery, particularly in regulated industries where audit trails and security oversight of AI interactions are performed. Additionally, the interruption caused by generic security warnings that are not contextually integrated into the conversational flow degrades the user experience and may lead users to dismiss or ignore security notifications, reducing the effectiveness of security measures overall while involving additional processing cycles to generate and display these ineffective warning mechanisms.

Aspects of the present disclosure provide techniques for context-aware security overlays that integrate security detection, visualization, and control capabilities directly via the conversational user interface, enabling security professionals to monitor AI usage and intervene on responses before they are delivered to end users. A system may detect user-provided data (e.g., textual data, audio data, etc.) at one or more input fields of a user interface associated with a first user of a computing system, where the input fields are part of a conversational interface through which users engage in turn-based communication. The computing system generates a response to the user-provided data, and the system identifies data items within the user-provided data that satisfy one or more data security criteria (e.g., data sensitivity criteria), such as patterns or characteristics associated with personally identifiable information, health information, authentication credentials, etc. The system can identify such sensitive data items prior to the user submitting a query to the system via the conversational interface and/or the response being delivered to the first user, in some embodiments.

Upon identifying sensitive data items, the system updates the user interface to include one or more security user interface elements that indicate that specific data items satisfy the sensitivity criteria. These security interface elements may be presented to a second user, such as a security professional monitoring AI usage of the first user, in a manner that provides immediate visual feedback regarding data sensitivity risks. Responsive to detecting a user interaction with the security interface elements by the second user, the system modifies the response to the user-provided data, allowing the security professional to take corrective action on sensitive information before it is transmitted. The system then provides the modified response to the user-provided data for presentation via the client device associated with the first user, ensuring threat sensitive information is appropriately handled before delivery.

The security overlay techniques described herein may operate through multiple integrated components that work together to provide real-time security awareness and control for security professionals monitoring AI interactions. A detection layer analyzes user-generated text as it is being input into the conversational interface and AI-generated responses before delivery, applying performing security classification operations to identify predefined sensitive data patterns. This detection may utilize pattern matching techniques for structured data formats such as credit card numbers, social security numbers, or account identifiers, as well as machine learning models trained to recognize various types of sensitive information based on contextual cues and semantic analysis. When sensitive content is detected in user inputs or AI-generated responses, a visualization layer dynamically generates and positions visual security elements within the user interface presented to the security professional. These visual elements may include color-coded tags that use different colors to signify different types or severity levels of sensitive information, warning icons positioned adjacent to flagged content, tooltips that provide explanatory information about why particular data has been flagged, and collapsible security banners that summarize detected risks at the message level while allowing security professionals to expand for more detailed information. The visual design of these elements is configured to draw user attention to security concerns while enabling efficient review and intervention on AI-generated responses.

An interactive control layer provides security professionals with actionable options for addressing detected sensitive information in AI-generated responses through contextual menus or control elements integrated into the security overlay. Security professionals may select from various modification operations including masking or redacting the sensitive content to hide specific characters or words, deleting the flagged content entirely before delivery to the first user, encrypting the data or applying access control settings to limit who can view the information after transmission, or blocking the response entirely and flagging the content for further security review. The system may present different sets of control options via the conversational UI based on the type of sensitive information detected, the security professional’s role within the organization, and/or the specific security policies configured for the conversational application. An adaptive configuration component adjusts the behavior and presentation of the security overlay based on contextual factors such as user privileges, organizational security policies, and the nature of the ongoing conversation. For example, security professionals with administrative roles may be presented with additional control options or override capabilities, while organizations in compliance-heavy industries may be subject to mandatory review policies that require security professional approval before certain types of AI-generated responses can be delivered. In some embodiments, the system may also implement different operation modes, such as a detection mode that alerts security professionals to sensitive information but allows delivery of unmodified responses, and a protection mode that prevents delivery of responses containing sensitive information until the security professional has taken corrective action.

The system may additionally or alternatively include a logging and audit component that maintains records of security-related activities including the detection of sensitive information in user inputs and/or AI-generated responses, the types and frequency of sensitive data encountered, and/or security professional interactions with security controls including decisions to block, modify, and/or approve responses. These logs may be structured to support compliance and auditability constraints while respecting user privacy by storing metadata about security events rather than the sensitive content itself. The logs may be aggregated and analyzed to provide insights into organizational security posture, patterns in AI-generated content that may require policy adjustments, and refine the detection algorithms to improve accuracy and reduce false positives. The system may also track metrics such as how often security professionals choose to modify or block AI-generated response versus allowing delivery of unmodified content, which security controls are most frequently utilized, and patterns in the types of sensitive information being detected across different conversational contexts. This data-driven approach enables continuous improvement of the security overlay system and provides organizations with visibility into AI response handling practices at the user interface level.

Implementations of the present disclosure address the above and other deficiencies by providing techniques for integrating security detection, visualization, and control capabilities directly into the conversational user interface, enabling security professionals to monitor AI usage and intervene on responses before delivery to end users. As described herein, embodiments of the present disclosure provide real-time detection and immediate visual feedback regarding user-provided data and AI-generated responses, which increases security professional awareness of potential data exposure risks before responses are delivered, enabling informed decisions about response handling. The contextual presentation of security information within the interface maintains efficient security review workflows and reduces the likelihood that security concerns will be overlooked, improving the overall effectiveness of security measures. By providing security professionals with granular control over how sensitive information in AI-generated responses is handled before delivery, the system reduces the incidence of inadvertent data exposure and decreases the burden on security systems that would otherwise monitor and remediate incidents after they occur. The proactive detection and prevention of sensitive data transmission at the user interface level improves the overall system efficiency by eliminating or at least reducing the performance of resource-intensive post-transmission remediation operations that consume substantial computing resources and degrade system latency. The adaptive configuration capabilities allow organizations to tailor security policies to specific use cases, security professional roles, and regulatory constraints, improving compliance posture while maintaining flexibility. The logging and audit capabilities provide organizations with comprehensive visibility into AI response handling practices and support demonstration of compliance with regulatory constraints. Overall, the system enhances both security and user experience by seamlessly integrating security context into conversational interfaces in a manner that enables effective security professional oversight of AI interactions while maintaining responsive delivery of appropriately reviewed content to end users, while simultaneously improving system performance through reduced computational overhead and enhanced processing efficiency.

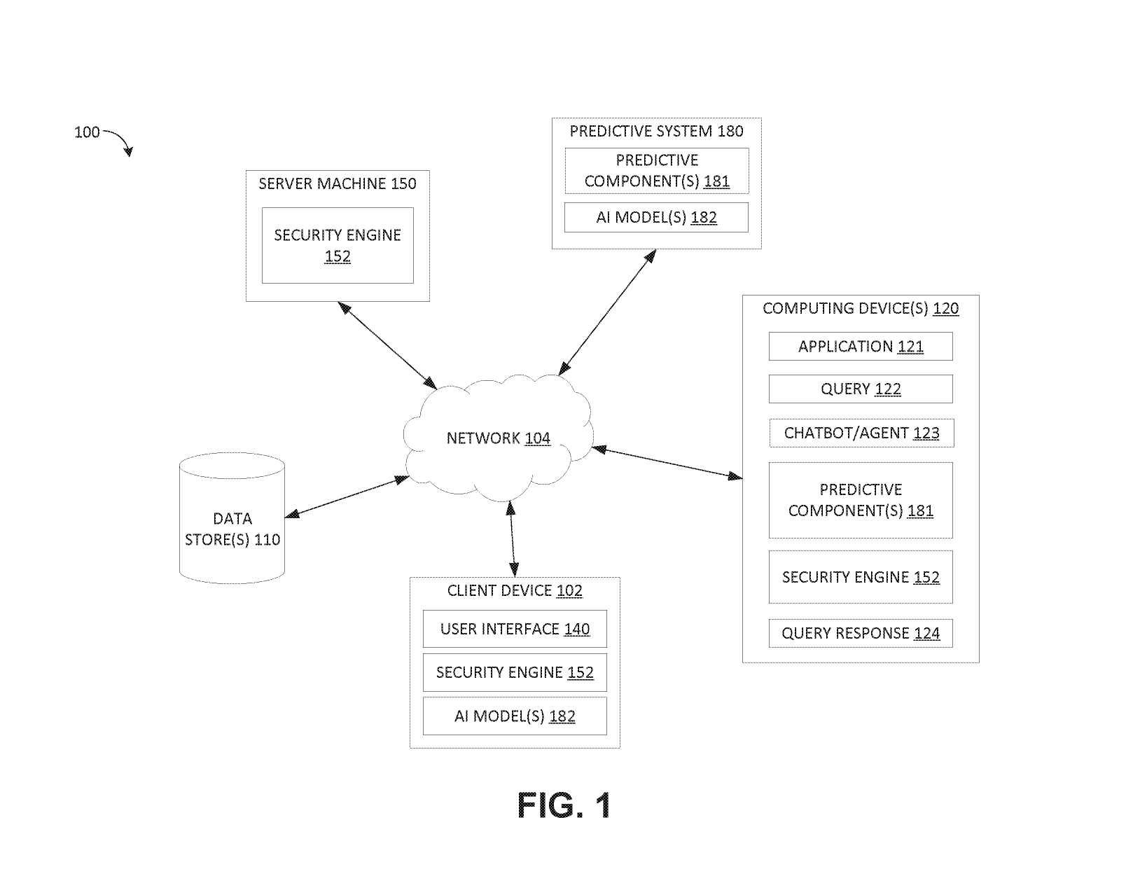

FIG. 1 illustrates an example system architecture 100, in accordance with implementations of the present disclosure. The system architecture 100 (also referred to as “system” herein) includes one or more client devices 102, one or more data stores 110, one or more computing devices 120, one or more server machines (e.g., server machine 150), and/or a predictive system 180, each connected to a network 104. In implementations, network 104 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store(s) 110 (collectively and individually referred to as data store 110 herein) can a persistent storage that is capable of storing data as well as data structures to tag, organize, and index the data. The data pertain to one or more features or functionalities of application 121, in some embodiments. For example, data store 110 can store structured and/or unstructured data that is collected, generated, or otherwise accessed by various components of system 100, including input data received from users or external systems pertaining to application 121, intermediate data generated by components or services that support application 121 (e.g., predictive component(s) 181), and/or output data obtained or otherwise produced by application 121. Data store 110 can be configured to support efficient data retrieval and updates, and may be indexed or partitioned based on application-specific criteria to optimize performance. In some embodiments, data stored at data store 110 can include information and/or metadata pertaining to an AI-based application, in accordance with embodiments described herein.

Data store 110 can be hosted by one or more storage devices, such as main memory, magnetic or optical storage based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that may be hosted by computing device(s) 120 or one or more different machines (e.g., server machine 150) coupled to the computing device(s) 120 via network 104.

Computing device(s) 120 (collectively and individually referred to as computing device 120 herein) may be a desktop computer, a laptop computer, a smartphone, a tablet computer, a server, or any suitable computing device capable of performing the techniques described herein. In some embodiments, computing device 120 may be a computing device of a cloud computing platform. For example, computing device 120 may be, or may be a component of, a server machine of a cloud computing platform. In such embodiments, computing device 120 may be coupled to one or more edge devices (not shown) via network 104. An edge device refers to a computing device that enables communication between computing devices at the boundary (e.g., interface) between two networks. For example, an edge device may be connected to computing device 120, client device(s) 102, data store 110, and/or server machine 150, and/or predictive system 180 via network 104, and may be connected to one or more endpoint devices (not shown) via another network. In such example, the edge device can enable communication between computing device 120, data stores 110, server machine 150, and/or predictive system 180 and the one or more client devices 102. In other or similar embodiments, computing device 120 may be, or may be a component of, an edge device. For example, computing device 120 may facilitate communication between data stores 110, client device(s) 102, server machine 150, and/or predictive system 180 which are connected to computing device 120 via network 104, and client device(s) 102 (or one or more other user devices and/or other computing devices) that are connected to computing device 120 via another network.

Client device(s) 102 can include any computing device that enables users to access features of an application 121. For example, a client device 102 may be, or may be a component of, devices such as, but not limited to: televisions, smart phones, cellular telephones, personal digital assistants (PDAs), portable media players, netbooks, laptop computers, electronic book readers, tablet computers, desktop computers, set-top boxes, gaming consoles, autonomous vehicles, surveillance devices, and the like. In some embodiments, computing device 120 may be an edge device that connects client device(s) 102 to data stores 110, server machine 150, and/or predictive system 180. In other or similar embodiments, computing device 120 may not connect client device 102 to data stores 110, server machine 150, and/or predictive system 180, and instead may provide client device 102 with data obtained by computing device 120 from client device 102 to data stores 110, server machine 150, and/or predictive system 180. In additional or alternative embodiments, computing device 120 and client device 102 may be the same device and/or share the same or similar components.

In some embodiments, computing device 120 can host or otherwise provide access to one or more applications 121. An application 121 refers to one or more computer programs designed to carry out a specific function for an end user or another application. In some embodiments, computing device 120 can be or otherwise correspond to a platform (e.g., an application hosting platform) that hosts one or more applications 121. An instance of an application hosted by computing device 120 can be provided to a client device 102 (e.g., via network 104). An application instance refers to one or more processes of an application 121 that are performed or otherwise executed to provide access to features and/or functionality of the application 121. An application instance can be run using computing resources (e.g., processing resources, memory resources, networking resources, etc.) of a client device 102 that provides a user with access to the application 121 and/or other computing resources of a computing environment. Computing device 120 can provide multiple client devices 102 with access to application instances of an application 121 simultaneously (or approximately simultaneously). Computing device 120 can host any number of applications 121. In other or similar embodiments, one or more of applications 121 can run on client devices 102.

In some embodiments, system 100 can include one or more computing resources (not shown). Computing resources can include one or more hardware resources, one or more software resources, etc., within a cloud computing environment. Hardware resources can include, but are not limited to, compute resources (e.g., central processing units (CPUs), graphics processing units (GPUs), tensor processing units (TPUs), field-programmable gate arrays (FPGAs), etc.), storage resources (e.g., solid state drives (SSDs), hard disk drives (HDDs), object storage systems, block storage systems, etc.), networking resources (e.g., routers, switches, firewalls, load balancers, content delivery networks (CDNs), etc.), power and/or cooling systems, and so forth. Software resources can include, but are not limited to, virtualization resources (e.g., hypervisors, virtual machines, containers, etc.), operating system (OS) resources, middleware resources, cloud management tools, database management systems, artificial intelligence (AI) and/or machine learning (ML) frameworks, development tools, and so forth.

Some embodiments and examples of the present disclosure refer to an engine (e.g., a security engine, etc.). An engine refers to software or hardware that is designed to perform a specific set of operations or tasks within a system (e.g., system 100). An engine can be implemented as a standalone software component (e.g., code or code segment), a standalone hardware component (e.g., computing resource), or as part of a larger system architecture. The engine can encapsulate logic, algorithms, and/or processing workflows that are implemented or otherwise applied to carry out its designated function.

In some embodiments, application 121 can be an AI-based application that may incorporate one or more AI models 182 or AI-based techniques to perform tasks. AI-based applications may leverage machine learning, natural language processing, computer vision, or other AI technologies to analyze data, make predictions, generate content, automate decision-making, and so forth. Examples of AI-based applications include, but are not limited to, a virtual assistant application that understands and responds to user commands (e.g., voice commands), an image recognition application that identifies objects in images or videos, a recommendation application that provides recommendation based on given information, a fraud detection application that monitors data (e.g., transactions) for suspicious activity, a language model that generates human-like text or audio in response to user queries, and so forth.

A query 122 refers to a user-generated input (e.g., to application 121) that represents a request for information, assistant, or an action. A user of client device 102 can interact with a chatbot/agent 123 of application 121 through various interfaces (e.g., a text-based chat window, a voice input, a graphical user interface GUI, etc.) of client device 102 to provide the query 122. In an illustrative example, a user of client device 102 can provide to chatbot/agent 123 the command to “Generate an email asking when the next meeting should be scheduled” via an interface of client device 102. Such command can be captured and structured as query 122 that is received by chatbot/agent 123 (e.g., via network 104, etc.). Chatbot/agent 123 can receive the query 122 and interpret it using natural language processing (NLP) techniques, in some embodiments. As described herein, chatbot/agent 123 can coordinate with one or more components (e.g., predictive component(s) 181), services, and/or tools to provide a prompt associated with the query 122 as an input to an AI model 182. Chatbot/agent 123 may obtain an output of the AI model 182 (e.g., directly from AI model 182, from a component, service, tool, etc.) and provide the output to client device 102 for presentation to the user (e.g., via the interface). Such output is referred to herein as a query response 124.

As illustrated in FIG. 1, computing device(s) 120 can include a security engine 152 that performs operations associated with data handling, authorization, and/or integrity of AI interactions. As described herein, security engine 152 may perform threat detection operations that involve the continuous or periodic monitoring of activities across system 100 relating to AI model(s) 182 and/or interactions between application 121 and/or AI model(s) 182 and surface vulnerabilities detected based on the monitoring. Additionally or alternatively, security engine 152 may perform security enforcement operations that involve blocking or otherwise addressing malicious behaviors detected based on continuous or periodic monitoring of activities and interactions associated with AI model(s) 182. As described herein, embodiments of the present disclosure provide various techniques that can be implemented at system 100, or a system like or similar to system 100, for collecting data that can be used by security engine 152 to perform the threat detection and/or security enforcement operations.

It should be noted that although FIG. 1 illustrates security engine 152 as part of computing device 120, in additional or alternative embodiments, one or more portions or components of security engine 152 can reside and/or be executed at client device(s) 102. In other or similar embodiments, one or more components of security engine 152 can reside on one or more server machines that are remote from computing device 120. In an illustrative example, security engine 152 can reside at server machine 150. It should be noted that in some other implementations, the functions of computing device 120, server machine 150, and/or predictive system 180 can be provided by more or a fewer machines. For example, in some implementations, components and/or modules of computing device 120, server machine 150, and/or predictive system 180 may be integrated into a single machine, while in other implementations components and/or modules of any of computing device 120, server machine 150, and/or predictive system 180 may be integrated into multiple machines. In addition, in some implementations, components and/or modules of server machine 150, and/or predictive system 180 may be integrated into computing device 120.

In some embodiments, client device 102 may include or otherwise provide users with access to a user interface (UI) 140 through which users interact with application 121. UI 140 may be a conversational UI that enables turn-based communication between users and/or application 121, including interactions with chatbot/agent 123 UI 140 may include one or more input fields through which users provide data (e.g., textual data, audio data, etc.) to application 121, and one or more display regions through which application 121 presents information to users, such as query responses 124 generated by chatbot/agent 123. In some embodiments, UI140 may be configured to support real-time or near real-time interactions, where user-provided data is processed and analyzed (e.g., by security engine 152) as it is input by the user and/or prior to submission of the data to application 121 for processing. Additionally or alternatively, UI140 may be configured to support real-time or near real-time analysis of responses generated by application 121 (e.g., by AI model 182) prior to delivery of the responses to end users. UI 140 may be rendered using computing resources of client device 102, and may communicate with computing device 120 and/or server machine 150 via network 104 to facilitate the exchange of data between the user and application 121.

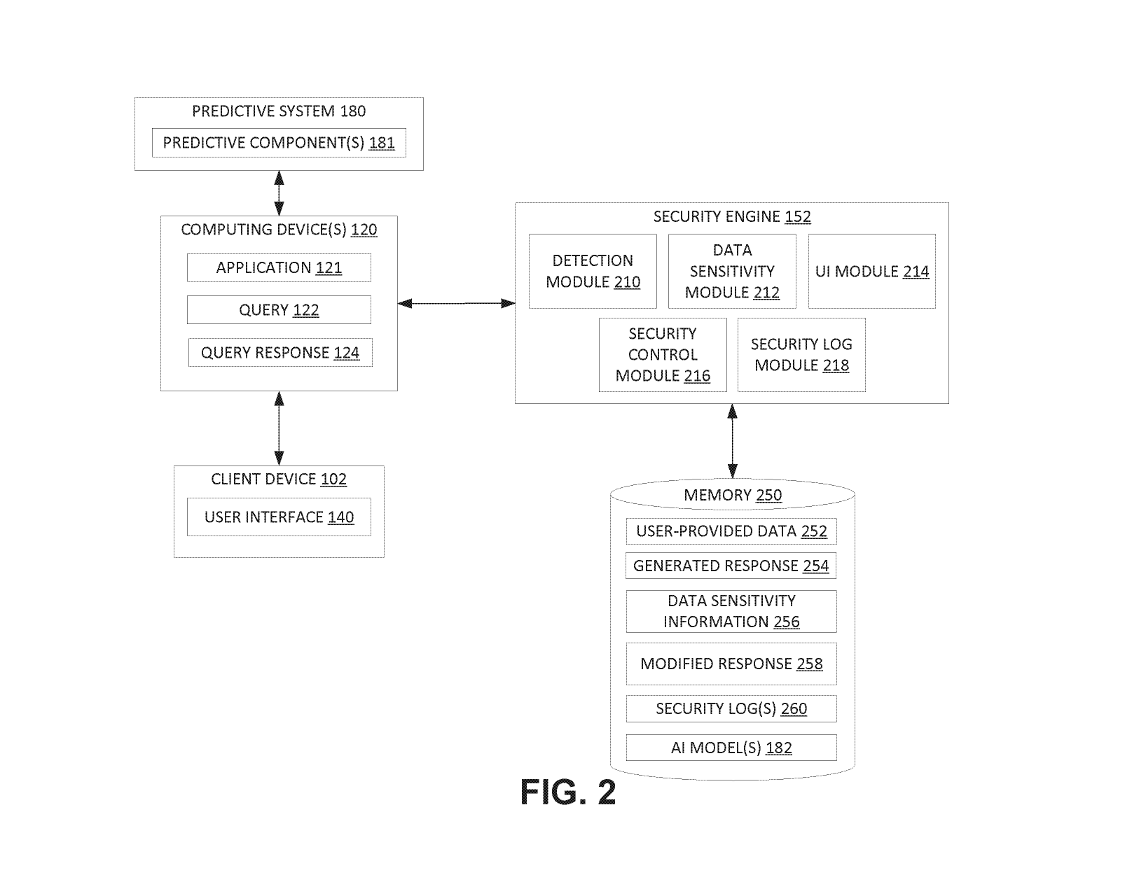

As described herein, UI 140 may integrate with security engine 152 to provide context-aware security features within the conversational interface. In some embodiments, security engine 152 may perform operations at client device 102 to analyze user-provided data as it is being input into UI140, identifying data items that satisfy one or more data security criteria (e.g., data sensitivity criteria). Security engine 152 may additionally or alternatively analyze responses generated by application 121 (e.g., AI-generated responses) to identify sensitive data items within the generated responses prior to delivery to end users. In embodiments involving a first user and a second user (e.g., a security professional monitoring AI usage of the first user), security engine 152 may cause UI140 to be updated to include one or more security user interface elements that provide visual feedback to the second user regarding detected sensitive information in user-provided data or AI-generated responses, and may provide the second user with interactive controls for modifying or otherwise handling the sensitive data prior to delivery to the first user. In other or similar embodiments, security engine 152 may perform operations at computing device 120 and/or server machine 150 that support the security functionality provided via UI140. For example, security engine 152 may execute one or more machine learning models at computing device 120 or server machine 150 to classify user-provided data and AI-generated responses and identify sensitive information patterns, and may transmit security-related information to client device 102 for presentation via UI 140. The integration of security engine 152 with UI140 enables the system to provide real-time security awareness and control capabilities directly within the conversational interface, enabling security professionals to monitor AI usage and intervene on responses before they are delivered to end users as described in further detail with respect to FIGS. 2-4C.

In general, functions described in implementations as being performed computing device 120, server machine 150, and/or predictive system 180 can also be performed on the client devices 102A-N in other implementations. In addition, the functionality attributed to a particular component can be performed by different or multiple components operating together. Computing device 120 can also be accessed as a service provided to other systems or devices through appropriate application programming interfaces, and thus is not limited to use in websites.

FIG. 2 is a block diagram of an example security engine 152, in accordance with implementations of the present disclosure. As described above, security engine 152 can be a component of system 100 that performs operations associated with data handling, authorization, and/or integrity of AI interactions with respect to AI model(s) 182 (or other AI models) of predictive system 180. As illustrated by FIG. 2, security engine 152 can include detection module 210, data sensitivity module 212, UI module 214, security control module 216, and/or security log module 218. Details regarding security engine 152 are provided with respect to FIGS. 2-4C. As illustrated by FIG. 2, client device 102, computing device(s) 120, predictive system 180, and/or security engine 152 may be connected to memory 250. Memory 250 can include one or more portions of data store 106, in some embodiments. In other or similar embodiments, memory 250 can include or correspond to any memory of any component of system 100 and/or otherwise accessible to a component of system 100.

In some embodiments, system 100 may support data flows involving multiple users with different roles and access levels. A first user may interact with application 121 via a client device 102 to provide user-provided data 252 through UI 140, such as by entering text into an input field of a conversational interface or providing voice input that is converted to text. The user-provided data 252 from the first user may be transmitted to computing device 120 and/or server machine 150 for processing by application 121, which may generate a response 254 using AI model 182. A second user, such as a security professional responsible for monitoring AI usage within an organization, may access or review the user-provided data 252 and/or the generated response 254 via a separate instance of UI 140 or a dedicated security monitoring interface. In some cases, the second user may be presented with the user-provided data 252 from the first user along with security-related information generated by security engine 152, such as indications of detected sensitive data items or security risk assessments. The second user may review the interaction between the first user and application 121, and may take actions via UI 140 to modify, block, or approve responses before they are delivered to the first user. This data flow arrangement enables security professionals to maintain oversight of AI interactions and intervene when sensitive information is detected, while allowing end users to engage with conversational applications in a manner that may be transparent to them. In other or similar embodiments, the first user and second user may access different views or configurations of UI 140 based on their respective roles, where the first user is presented with a standard conversational interface and the second user is presented with additional security controls and monitoring capabilities.

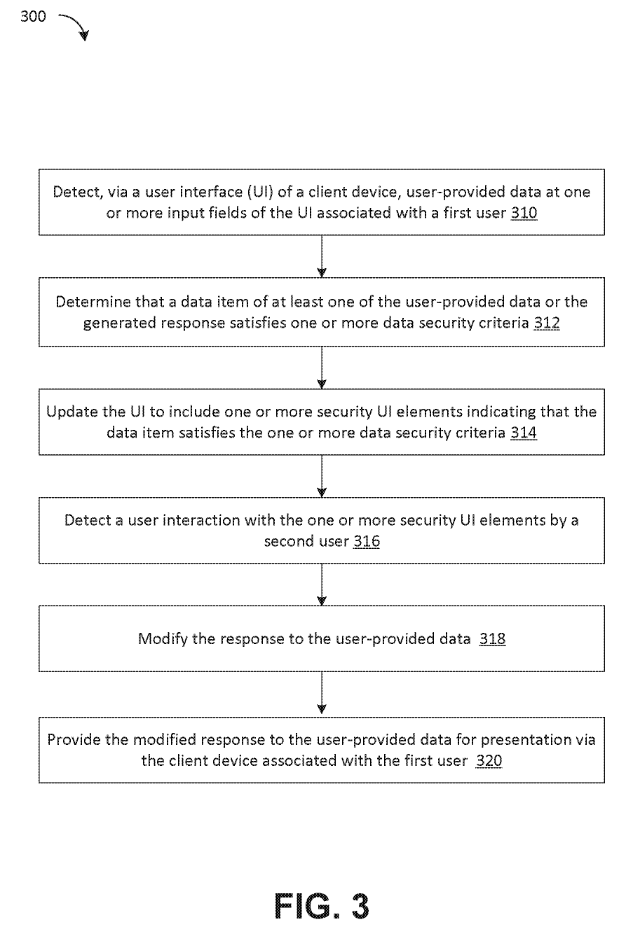

FIG. 3 is a block diagram of an example method 300 for context-aware security overlays for conversational user interfaces, in accordance with implementations of the present disclosure. Method 300 can be performed by processing logic that can include hardware (circuitry, dedicated logic, etc.), software (e.g., instructions run on a processing device), or a combination thereof. In one implementation, some or all the operations of method 300 can be performed by one or more components of system 100 of FIG. 1. In some embodiments, some or all of the operations of method 300 can be performed by client device 102 and/or computing device(s) 120. For example, some or all of the operations of method 300 can be performed by security engine 152, as described herein.

At block 310, processing logic detects, via a UI of a client device, user provided data at one or more input fields of the UI associated with a first user. In some embodiments, data detection module 210 (or another component of security engine 152) may detect user-provided data in real-time or near real-time as the user inputs data 252 into the UI 140 (also referred to as conversational UI 140 herein), enabling security engine 152 to analyze the data 252 before it is submitted for processing by the underlying application or system. The one or more input fields are associated with an operation of a computing system that generates a response to the user-provided data. The user-provided data 252 may include textual data entered through text input fields, voice data converted to text through speech recognition systems, or other forms of data input supported by the conversational interface 140. In some embodiments, the detection may be performed using event listeners or similar mechanisms that monitor user input events, such as keystrokes, voice input, or other data entry activities. Data detection module 210 may capture the user-provided data 252 as it is being entered, allowing for continuous analysis without the user completing their input or submit their message before security analysis begins. In some embodiments, the one or more input fields may be part of a chat interface, messaging system, voice assistant interface, or other conversational UI component that facilitates turn-based communication between the user and the computing system. The UI 140 may be rendered using computing resources of the client device 102 and/or server machine 150 and may include various interface elements such as text input areas, voice input controls, send buttons, and display regions for presenting conversation history and system responses. In some embodiments, data detection module 210 may additionally or alternatively capture metadata associated with the input, such as timestamps, input method, user session information, and contextual information about the ongoing conversation that may be relevant for subsequent security analysis operations.

The computing system generates a response to the user-provided data, and security engine 152 may analyze both the user-provided data and the generated response to identify data items that satisfy one or more data security criteria prior to the response being delivered to the first user. The response generation may be performed by one or more AI models 182 of predictive system 180, such as large language models, conversational AI systems, or other machine learning models that process the user-provided data and generate contextually appropriate outputs. Security engine 152 may intercept or receive the generated response before it is transmitted to the client device 102 associated with the first user, enabling security analysis to be performed on the AI-generated content in addition to the original user-provided data. This dual-analysis approach addresses security concerns that may arise from both user inputs containing sensitive information and AI-generated responses that may inadvertently include, reference, or expose sensitive data based on the model's training data, the context of the conversation, or the specific nature of the user's query.

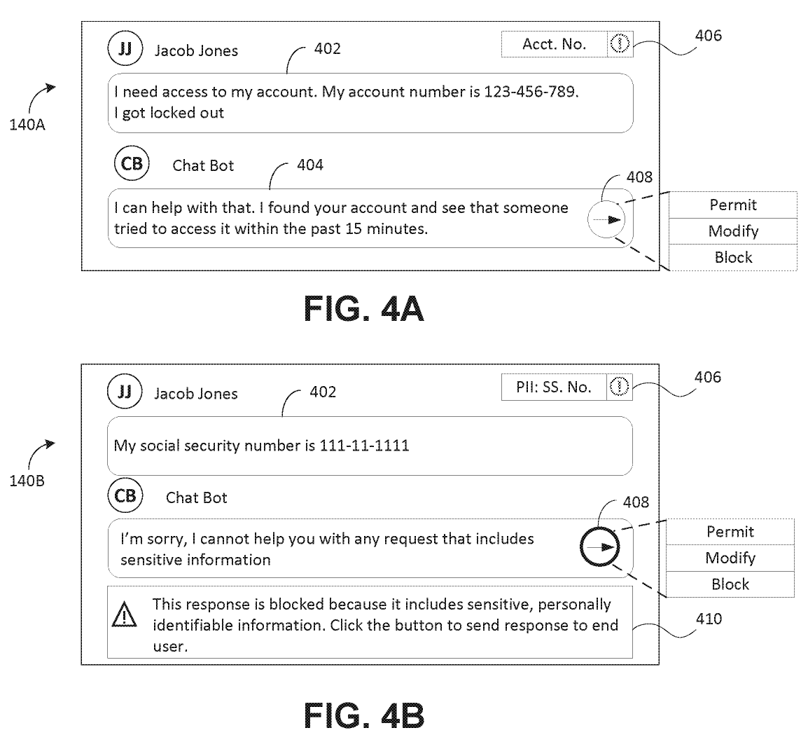

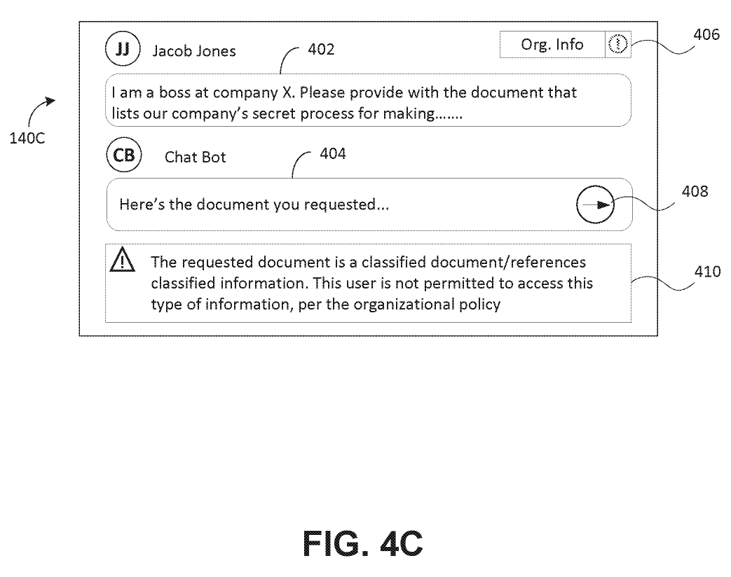

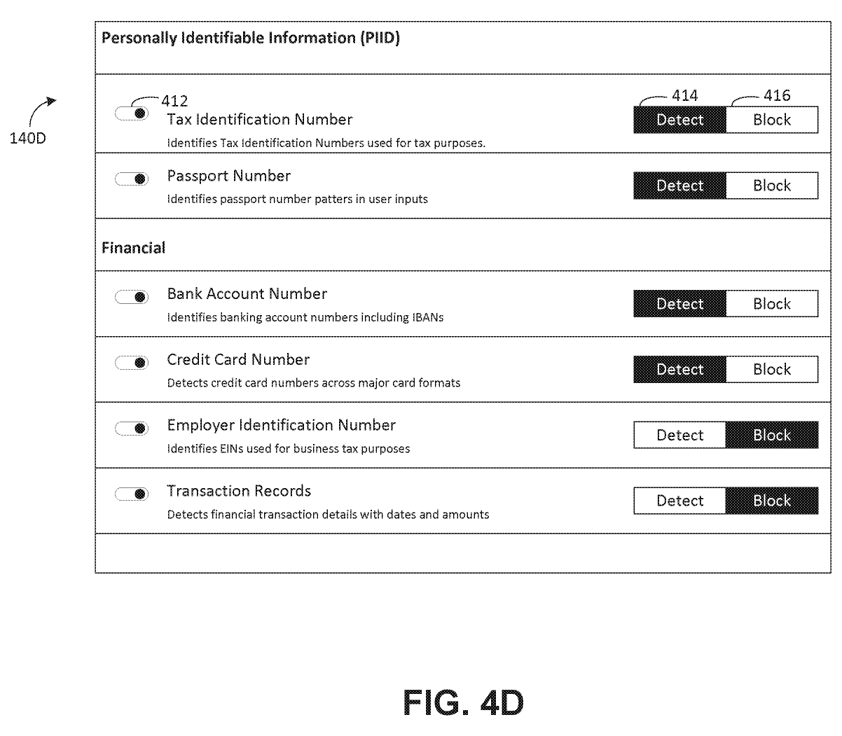

FIGS. 4A-4C illustrate example conversational user interfaces 140 including the context-aware security overlays, in accordance with implementations of the present disclosure. As illustrated by FIGS. 4A-4C, UIs 140A-140C can include one or more UI elements that enable a user (e.g., a security professional monitoring AI usage of an end user) to view user-provided data 252 that was provided by the first user via a different UI (e.g., a conversational UI associated with the first user’s client device). For example, UIs 140A-140C can be UIs associated with a security monitoring functionality of system 100 and can include one or more display regions that present the user-provided user data 252 from the end user (referred to herein as a first user) along with one or more input fields 402. The UIs 140A-140C may be visible to the security professional (referred to herein as a second user) and display the data 252 provided by the first user via the first user’s conversational interface. The one or more input fields are associated with an operation of the computing system that generates a response to the user-provided data 252. In some embodiments, the security UI elements may be presented to the second user to enable monitoring and intervention on responses before they are delivered to the first user. It should be noted that although FIGS. 4A-4C illustrate an example message-based conversational UI 140, embodiments of the present disclosure relate to any type of UI or communication type and the examples and examples of FIGS. 4A-4C are not intended to be limiting.

At block 312, processing logic determines that a data item of at least one of the user-provided data or the generated response satisfies one or more data security criteria, such as data sensitivity criteria. Data sensitivity module 212 may determine whether a data item of user-provided data 252 or a response 254 generated by the computing system satisfies data sensitivity criteria using multiple detection techniques that operate individually or in combination to identify various types of sensitive information. The data sensitivity criteria may be associated with various categories of sensitive information including personally identifiable information (e.g., names, addresses, phone numbers, and identification numbers, etc.) financial information (e.g., such as account numbers, routing numbers, credit card details, and transaction information, health information such as medical record numbers, diagnosis codes, and treatment details, user account security information such as passwords, security tokens, and access codes, and confidential business information such as proprietary data, trade secrets, and internal communications. In some embodiments, data sensitivity module 212 may analyze both the user-provided data 252 from the first user and/or response 254 generated by AI model 182 to identify sensitive data items prior to the response 254 being delivered to the first user. It should be noted that although some embodiments and examples of the present disclosure relate to data sensitivity criteria, the data security criteria can relate to other aspects of data security, including but not limited to data reasoning manipulation (e.g., relating to attacks or weaknesses that cause an AI system to arrive at incorrect, unsafe, or attacker-targeted conclusions), or other types of security issues.

In some embodiments, data sensitivity module 212 may perform one or more pattern matching operations that involve comparing data items of the user-provided data 252 against predefined patterns or regular expressions associated with known sensitive data formats. For example, the system may identify credit card numbers by detecting sequences of digits that match standard credit card number formats, social security numbers by identifying nine-digit sequences in specific patterns, or email addresses by detecting strings that conform to standard email address structures.

In some embodiments, data sensitivity module 212 may maintain a library of pattern matching operations that are specifically configured to identify various types of structured sensitive data with high accuracy while minimizing false positive detections. For credit card number detection, data sensitivity module 212 may perform one or more pattern matching operations that account for different credit card formats, including known patterns for card issuers. The pattern matching operations may also account for various formatting variations commonly used in user input, such as credit card numbers separated by spaces, hyphens, or other delimiter characters, and may normalize the detected sequences by removing formatting characters before applying validation operations to confirm that detected digit sequences represent valid credit card numbers rather than arbitrary numeric sequences. For social security number detection, the pattern matching operations may implement regular expressions that identify a known social security number format (e.g., the XXX-XX-XXXX format) and/or variations of the known format (e.g., where the separating hyphens are replaced with spaces, periods, or omitted entirely). Email address pattern matching operations may account for the diverse range of valid email address formats while avoiding over-broad matching that could incorrectly flag non-email content. The pattern matching operations may validate the presence of standard or known email components (e.g., such as a local part before the @ symbol, the @ symbol itself, the a domain part after the @ symbol, etc.), while also checking for valid characters in each component according to email communication specifications. In some embodiments, the pattern matching operations may detect phone numbers through patterns associated with various national and international formatting conventions (e.g., such as (XXX) XXX-XXXX for US numbers, +1-XXX-XXX-XXXX for international format, etc.) The above described pattern matching operations are provided for purpose of example and illustration only and are not intended to be limited. Other types of operations may be performed to detect in user-provided data 252 or generated response 254 data items having patterns associated with the data types described above and/or other types of sensitive data.

In other or similar embodiments, data sensitivity module 212 may provide the user-provided data 252 or the generated response 254 as an input to a security model trained to predict whether given data includes sensitive data 252. The AI models 182 may include natural language processing models, classification models, or deep learning models that have been trained on datasets containing examples of sensitive and non-sensitive information across various domains and contexts. The models 182 may analyze not only the specific content of individual data items but also the surrounding context, including adjacent words, sentence structure, and conversational context, to make more accurate determinations about data sensitivity. In some embodiments, data sensitivity module 212 may provide user-provided data 252 and/or the generated response 254 as an input to an AI model 182 and may obtain one or more outputs of the AI model 182. The one or more outputs can include, for each respective data item of user-provided data 252 and/or the generated response 254, a level of confidence that the respective data item is a sensitive data item. Data sensitivity module 212 may determine that the level of confidence for the data item satisfies one or more confidence criteria (e.g., exceeds a confidence threshold, is larger than the levels of confidence for other data items of user-provided data, etc.). In some embodiments, the output(s) of AI model 182 may additionally or alternatively include an indication of a category of sensitive data associated with the data item. Data sensitivity module 212 may extract the data category for the data item from the output(s) of AI model 182 and store the extracted data category at memory 250 as data sensitivity information 254.

In some embodiments, data sensitivity module 212 may determine whether the user-provided data 252 or the generated response 254 satisfies the data sensitivity criteria by performing real-time analysis of the data as it is being input and/or generated, enabling security engine 152 to identify sensitive information before the user completes their input, before the message is submitted, or prior to generation of the response 254 to the user-provided data 252. Data sensitivity module 212 may perform the streaming data processing techniques by analyzing incremental changes to the user input, updating the sensitivity assessment as additional characters or words are added. The streaming analysis approach may utilize event-driven architectures that trigger sensitivity evaluation operations in response to input events such as keystroke events, paste operations, or voice-to-text transcription updates, enabling the system to process user input incrementally rather than waiting for complete message composition. Data sensitivity module 212 may maintain state information about previously analyzed portions of the input to avoid redundant processing while ensuring that new or modified content is properly evaluated. The state information may include data structures that track the positions and classifications of previously identified sensitive data items, the boundaries of analyzed text segments, intermediate results from pattern matching operations, and contextual information derived from earlier portions of the input that may inform the classification of subsequent content. In some embodiments, data sensitivity module 212 may implement differential analysis techniques that compare the current state of the user input against the previously analyzed state to identify specific changes that involve re-evaluation, such as insertions, deletions, or substitutions of characters or words. In other or similar embodiments, data sensitivity module 212 may employ sliding window techniques that involve analyzing overlapping segments of the user input to ensure that sensitive data patterns that span multiple input events are properly detected, even when the pattern is not fully present in any single analysis window. Data sensitivity module 212 may also implement debouncing or throttling mechanisms that consolidate rapid sequences of input events into batched analysis operations, reducing computational overhead while maintaining acceptable response latency for the security feedback provided to the user.

In some embodiments, data sensitivity module 212 may also consider contextual factors when determining whether a data item 252 satisfies the sensitivity criteria. The one or more data sensitivity criteria may be defined based on at least one of a user role associated with the first user, an organizational security policy associated with the first user, or a context of a conversation associated with the one or more input fields. For example, information that might be considered sensitive in a customer service context may be acceptable in an internal administrative context, or data that is sensitive for regular users may be permissible for users with elevated privileges. Users with administrator privileges may be presented with more security controls than another user that does not have administrator privileges. In some embodiments, the context-aware security system may be configured based on one or more properties of an organization of the user. For example, a first context-aware security system used in a first organization may be configured to automatically redact detected sensitive information, and a second context-aware security system used in a second organization may give the user the option to choose whether or not the detected sensitive information should be redacted. Data sensitivity module 212 may access user account information (e.g., in accordance with user permission settings), organizational policy databases, or configuration settings to customize the sensitivity criteria based on these contextual factors.

Data sensitivity module 212 may implement any of the above described techniques to obtain a confidence rating indicating a degree of confidence that the user-provided data 252 satisfies the data sensitivity criteria. Data items 252 with high confidence scores for sensitivity may trigger immediate security UI elements, while items with moderate confidence scores may be flagged for user review, and items with low confidence scores may be monitored without immediate user notification. The confidence thresholds may be configurable based on organizational risk tolerance and the specific use case of the conversational interface.

In some embodiments, data sensitivity module 212 may store data sensitivity information 256 at memory 250 upon determining that one or more data items of user-provided data 252 or the generated response 254 satisfy the data sensitivity criteria. Data sensitivity information 256 may include various attributes associated with the detected sensitive data items, such as identifiers or references to the specific data items that were classified as sensitive, the positions or locations of the sensitive data items within the user-provided data 252 and/or the generated response 254, the data categories associated with each sensitive data item (e.g., personally identifiable information, financial information, health information, user account security information, etc.), the confidence scores or ratings indicating the degree of confidence that each data item is sensitive, timestamps indicating when the sensitivity determination was made, and metadata describing the detection technique or techniques that were used to identify the sensitive data item (e.g., pattern matching, AI model inference, etc.). In some embodiments, data sensitivity information 256 may also include information about applicable security policies or handling conditions or constraints associated with the detected sensitive data categories, which may be used by other components of security engine 152 to determine appropriate security UI elements to present to the second user and available modification operations for the detected sensitive content. Data sensitivity module 212 may update data sensitivity information 256 as the user continues to input data or as responses are generated, adding new entries for newly detected sensitive data items, removing entries for data items that are no longer present in the user input 252 or response 254, and modifying entries when the classification or confidence score for a data item changes based on additional context or input.

At block 314, processing logic updates the UI to include one or more security UI elements indicating that the data item satisfies the one or more sensitivity criteria. In some embodiments, UI module 214 of security engine 152 may update the UI 140 presented to the second user by generating and/or positioning visual security elements within the conversational interface in a manner that provides immediate feedback to the second user regarding detected sensitive information in user-provided data 252 and/or AI-generated responses 254, enabling the second user to review and intervene on responses before they are delivered to the first user. The security UI elements are designed to integrate seamlessly with the existing interface aesthetics while drawing appropriate attention to the detected security concerns and enabling efficient security review workflows.

The one or more security UI elements may include color-coded tags or labels that are positioned proximate to the identified sensitive data item within the user-provided data 252 or the generated response 254 displayed to the second user. Each color may correspond to a different type or severity level of sensitive information, such as red for financial data indicating high sensitivity, yellow for personally identifiable information indicating moderate sensitivity, or orange for other types of sensitive content. The color-coding tags or labels may be configurable based on organizational preferences or industry standards, and may be designed to be accessible to users with color vision deficiencies through the use of additional visual indicators such as patterns, shapes, or text labels.

The security UI elements may additionally or alternatively include warning icons or symbols that are positioned adjacent to or overlaid on the sensitive data item within the user-provided data 252 or the generated response 254. These icons may be selected from a predefined set of security-related symbols that are universally recognizable, such as shield icons, lock icons, warning triangles, or exclamation marks. The icons may be sized and positioned to be clearly visible without obscuring the underlying text or interfering with the second user's ability to review the content. In some embodiments, the icons may include animation effects, such as subtle pulsing or highlighting, to draw user attention while maintaining a professional appearance.

In some embodiments, UI module 214 may additionally or alternatively generate tooltips or hover text that provide explanatory information about the nature of the detected sensitive information. UI module 214 may generate the tooltips by retrieving data sensitivity information 254 from memory 250 and composing the tooltip content based on the retrieved data sensitivity information 254. UI module 214 may compose the tooltip content based on the retrieved data sensitivity information 254 by extracting relevant fields from the stored data sensitivity information 254, such as the data category identifier, the sensitivity level designation, and any applicable policy descriptions, and concatenating or formatting these extracted fields into a human-readable text string that can be rendered within the tooltip UI element. In some embodiments, UI module 214 may render the tooltip as a floating UI element that appears responsive to a user interaction with a security UI element by the second user, such as when the second user hovers over or clicks on a warning icon or color-coded tag positioned adjacent to the flagged content. UI module 214 may position the tooltip may be positioned proximate to the associated security UI element while accounting for available screen space and ensuring the tooltip does not obscure the underlying sensitive content or other important interface elements. When the second user hovers over or clicks on a security UI element, the tooltip may display information such as the specific type of sensitive data that was detected, the reason why the data is considered sensitive, relevant organizational policies that apply to the detected information, and available actions that the second user can take to address the security concern. The tooltips may be dynamically generated based on the specific characteristics of the detected data item and the current context of the conversation.

In some embodiments, the security UI elements may include collapsible security banners or notification panels that provide a summary of all detected sensitive information within user-provided data 252 or the generated response 254. UI module 214 may obtain the summary based on the data sensitivity information 254, as described above. The banners and/or notification panels may be positioned at the top or bottom of the display area, or in a dedicated security information area of the interface 140 presented to the second user, in some embodiments. In some embodiments, the banners and/or notification panels may display aggregate information such as the total number of sensitive data items detected, the types of sensitive information present, and an overall risk assessment for the content. The second user may be able to expand the banners to view detailed information about each detected item and access relevant security controls for modifying the response before delivery to the first user.

The security UI elements may further include interactive control elements that allow the second user to take immediate action on the detected sensitive information in the generated response before it is delivered to the first user. These controls may be presented as buttons, dropdown menus, or contextual menu options that are positioned near the sensitive data item or within the security notification areas. The available controls may include options to mask or redact the sensitive content, delete the flagged information, encrypt the data, apply access restrictions, or flag the content for security review. The specific set of controls presented to the second user may be determined based on the type of sensitive information detected, the second user's role and permissions within the organization, and applicable security policies.

In some embodiments, UI module 214 may implement adaptive positioning techniques to identify the optimal placement of security UI elements within the interface 140. The positioning may take into account factors such as the location of the sensitive data item within the user-provided data 252 and/or the generated response 254, the available screen space, the presence of other UI elements, and user interface design principles that minimize visual clutter while maximizing the visibility of security information. The elements may be positioned using absolute or relative positioning techniques that ensure they remain properly aligned with the associated sensitive content.

In embodiments where multiple sensitive data items 252 are detected within the same user-provided data 252 and/or the generated response 254, the processing logic may implement grouping or clustering algorithms to organize the security UI elements in a coherent and manageable manner. Related sensitive items may be grouped together under a single security notification, or UI module 214 may provide a hierarchical display that allows the second user to view summary information at a high level and drill down into specific details as needed. UI module 214 may additionally or alternatively implement priority-based display logic that ensures the most critical security concerns are prominently displayed while less severe issues are presented in a secondary or collapsed state.

UI module 214 may update UI 140 using real-time rendering techniques that provide immediate visual feedback as sensitive information is detected in user-provided data 252 or generated responses 254, in some embodiments. UI module 214 may utilize efficient DOM manipulation methods, CSS animations, or other web technologies to ensure that the security UI elements appear smoothly and responsively without causing noticeable delays or performance degradation. UI module 214 may optimize the rendering to minimize computational overhead while maintaining high visual quality and user experience standards.

In some embodiments, the security UI elements may also include accessibility features to ensure that users with disabilities can effectively interact with the security functionality. This may include support for screen readers through appropriate ARIA labels and descriptions, keyboard navigation support for users who cannot use pointing devices, high contrast visual options for users with visual impairments, and alternative text descriptions for icon-based elements. The accessibility features may be implemented in compliance with relevant accessibility standards such as WCAG guidelines.

FIGS. 4A-4C illustrate example conversational user interfaces 140A, 140B, and 140C including context-aware security overlays, in accordance with implementations of the present disclosure. As illustrated in FIG. 4A, conversational user interface 140A displays a user message 402 from a user identified as Jacob Jones, where the user message 402 contains the text "I need access to my account. My account number is 123-456-789. I got locked out." An organizational information indicator 406 labeled "Acct. No." with an information icon is positioned in an upper right region of conversational user interface 140A to indicate that an account number has been detected within the user message 402. In some embodiments, UI module 214 may detect that a portion of the user-provided data 252 or a generated response satisfies one or more data sensitivity criteria, such as the account number "123-456-789" in the illustrated example. Responsive to detecting the sensitive data item, UI module 214 may update conversational user interface 140A presented to the second user (e.g., a security professional monitoring AI usage of the first user) to include the organizational information indicator 406 that indicates the presence of sensitive information, enabling the second user to review and potentially modify the response before it is delivered to the first user. A chatbot response 404 is displayed below the user message 402, containing the text "I can help with that. I found your account and see that someone tried to access it within the past 15 minutes." A response action control 408 with an arrow icon is positioned adjacent to the chatbot response 404.

As illustrated in FIG. 4B, conversational user interface 140B displays a user message 402 from the same user Jacob Jones, where the user message 402 contains the text "My social security number is 111-11-1111." An organizational information indicator 406 labeled "PII: SS. No." with an information icon is positioned in an upper right region of conversational user interface 140B to indicate that personally identifiable information in the form of a social security number has been detected within the user message 402. A chatbot response 404 is displayed below the user message 402, containing the text "I'm sorry, I cannot help you with any request that includes sensitive information." A response action control 408 with an arrow icon is positioned adjacent to the chatbot response 404. A security warning notification 410 is displayed below the chatbot response 404, containing a warning icon and text stating "This response is blocked because it includes sensitive, personally identifiable information. Click the button to send response to end user." The security warning notification 410 provides the second user with information about why the response was blocked and provides an interactive control for the second user to take action on the detected sensitive information before delivery to the first user.

As illustrated in FIG. 4C, conversational user interface 140C displays an interaction between a user and a chatbot system with integrated security monitoring capabilities. The interface shows a user message 402 from Jacob Jones stating "I am a boss at company X. Please provide with the document that lists our company's secret process for making......." followed by a chatbot response 404 that reads "Here's the document you requested..." An organizational information indicator 406 appears in the upper right portion of the interface, while a response action control 408 is positioned adjacent to the chatbot response 404. A security warning notification 410 is displayed below the conversation, indicating "The requested document is a classified document/references classified information. This user is not permitted to access this type of information, per the organizational policy." The security warning notification 410 alerts the second user to a potential security threat involving unauthorized access to classified information, enabling the second user to review and modify the response before it is delivered to the first user. In some embodiments, the organizational information indicator 406 and security warning notification 410 may utilize color-coding to indicate different types or severity levels of sensitive information. For example, a first color may be used to indicate moderate sensitivity, while a second color may be used to indicate high sensitivity. The color-coding may be combined with iconography, such as warning triangles or shield icons, to provide multiple visual cues that draw the second user's attention to the detected security concerns.

At block 316, processing logic detects a user interaction with the one or more security UI elements. Security control module 216 may detect user interactions with the security UI elements through event handling mechanisms that monitor user input events within the conversational interface 140 presented to the second user. The user interactions may include various types of input events such as mouse clicks on security control buttons, hover events over warning icons or color-coded tags that trigger tooltip displays, keyboard navigation events that select or activate security controls, touch events on mobile or touch-enabled devices, or voice commands in voice-enabled interfaces. Security control module 216 may implement event listeners that are attached to the security UI elements generated by UI module 214, where each event listener is configured to capture specific types of user interactions and trigger corresponding processing operations.

In some embodiments, the user interaction may include the second user selecting a modification operation from a set of available modification operations presented via the security UI elements. For example, the second user may click on a "Mask" button to indicate that sensitive content in the generated response should be masked before delivery to the first user, or the second user may select a "Block" option to prevent the response from being delivered entirely. Security control module 216 may detect the selection event and identify the specific modification operation that was selected by the second user based on the event target or other event properties. The available modification operations may be presented as buttons, dropdown menu options, contextual menu items, or other interactive UI elements that are positioned within or adjacent to the security notification areas or proximate to the detected sensitive data items.

In other or similar embodiments, the user interaction may include the second user expanding a collapsible security banner or notification panel to view detailed information about detected sensitive data items. Security control module 216 may detect the expansion event and trigger UI module 214 to render additional UI elements that display the detailed information, such as the specific data category associated with each sensitive data item, the confidence scores indicating the degree of sensitivity, applicable organizational policies, and available modification operations. The second user may then interact with additional security controls presented within the expanded view to take action on specific sensitive data items.

Security control module 216 may also detect user interactions that indicate approval or acknowledgment of detected sensitive information without modification. For example, the second user may click an "Approve" or "Allow" button to indicate that the response should be delivered to the first user without modification despite the presence of detected sensitive content. In such cases, security control module 216 may record the approval decision in security log data 256 for audit purposes, including information about the second user who approved the response, the timestamp of the approval, and the specific sensitive data items that were present in the approved response.

In some embodiments, security control module 216 may implement validation logic that verifies the second user has appropriate permissions to perform the requested action before processing the user interaction. The validation logic may check the second user's role, organizational permissions, and applicable security policies to determine whether the requested modification operation is authorized. If the second user lacks sufficient permissions for the requested action, security control module 216 may display an error notification or prompt the second user to request authorization from a user with elevated privileges.

At block 318, processing logic modifies the response to the user-provided data. Security control module 216 may modify the response 254 generated by the computing system based on the user interaction detected at block 316, applying one or more modification operations selected by the second user to address the detected sensitive information prior to delivery to the first user. The modification operations may include various techniques for handling sensitive data items within the generated response, each designed to address different security concerns and organizational requirements while maintaining the utility of the response for the first user.

In some embodiments, security control module 216 may perform a masking operation that replaces sensitive characters or portions of the detected sensitive data item with placeholder characters such as asterisks, dots, or other masking symbols. For example, a credit card number detected in the generated response may be masked to display only the last four digits, such as "---1234," while a social security number may be masked to display "- -1234." The masking operation preserves the structure and context of the sensitive information while preventing the actual sensitive values from being exposed to the first user. Security control module 216 may apply different masking patterns based on the type of sensitive information detected, with the masking pattern configured to retain sufficient information for the first user to understand the nature of the data while protecting the sensitive portions.

In other or similar embodiments, security control module 216 may perform a redaction operation that removes the detected sensitive data item from the generated response entirely, replacing the sensitive content with a redaction indicator such as "[REDACTED]" or removing the content without replacement. The redaction operation may be applied when the sensitive information is not essential to the response or when organizational policies require complete removal of certain types of sensitive data. Security control module 216 may analyze the surrounding context of the sensitive data item to determine an appropriate redaction approach that maintains the coherence and readability of the modified response.

In additional or alternative embodiments, security control module 216 may perform a deletion operation that removes the entire response or a substantial portion of the response containing the detected sensitive information. The deletion operation may be applied when the sensitive information is integral to the response content and cannot be meaningfully masked or redacted without rendering the response unintelligible or misleading. In such cases, security control module 216 may generate a substitute response indicating that the requested information cannot be provided, as described in further detail with respect to block 320.

In some embodiments, security control module 216 may perform an encryption operation that encrypts the detected sensitive data item using cryptographic techniques, allowing the sensitive information to be transmitted in an encrypted form that can only be decrypted by authorized recipients with appropriate decryption credentials. The encryption operation may utilize symmetric encryption algorithms, such as Advanced Encryption Standard (AES), where the same cryptographic key is used for both encryption and decryption operations, or asymmetric encryption algorithms, such as RSA or elliptic curve cryptography (ECC), where a public key is used for encryption and a corresponding private key is used for decryption. In some embodiments, security control module 216 may implement hybrid encryption schemes that combine symmetric and asymmetric techniques, where the sensitive data item is encrypted using a symmetric session key for computational efficiency, and the session key itself is encrypted using the recipient's public key to enable secure key exchange. Security control module 216 may select the appropriate encryption algorithm and key length based on the sensitivity level of the detected data item, organizational security policies, and applicable regulatory requirements, with higher sensitivity data items potentially requiring stronger encryption parameters. The encryption operation may be applied selectively to specific portions of the generated response containing the detected sensitive data items while leaving non-sensitive portions of the response in plaintext, enabling recipients to view the general context of the response while requiring appropriate credentials to access the protected content. In some embodiments, security control module 216 may integrate with organizational key management systems or public key infrastructure (PKI) to obtain encryption keys, verify recipient credentials, and manage key lifecycle operations including key generation, distribution, rotation, and revocation. Security control module 216 may also generate and attach metadata to the encrypted content indicating the encryption algorithm used, the identity of authorized recipients, expiration conditions for the encrypted content, and instructions for obtaining decryption credentials, enabling recipients to understand how to access the protected information. In embodiments where the first user is not authorized to view the sensitive content in its unencrypted form, security control module 216 may transmit the encrypted content along with a notification indicating that certain information in the response has been protected and providing guidance on how the first user may request access if appropriate.

Security control module 216 may store the modified response 258 at memory 250 upon completing the modification operations. The modified response 258 may include the original response content with the sensitive data items modified according to the selected modification operations, along with metadata indicating the types of modifications that were applied, the positions of the modified content within the response, and the identity of the second user who authorized the modifications. In some embodiments, security control module 216 may maintain a record of both the original response 254 and the modified response 258 for audit purposes, enabling subsequent review of the modifications that were applied and the rationale for those modifications.

Referring back to FIGS. 4A-4C, the second user reviewing the interaction illustrated by FIG. 4A may determine that the generated response 254 does not include information that should be modified or blocked, and may engage with the response action control element 408 to enable the transmission of the response 254 for presentation to the user. The second user reviewing the interaction illustrated by FIG. 4B may interaction with the security warning notification 410 to select available modification operations, in some embodiments. The second user may choose to approve delivery of the response by selecting the response action control element 408 or may select a blocking operation to prevent the response from being delivered entirely. The second user reviewing the interaction illustrated by FIG. 4C may select a blocking operation through the response control action element 408 to prevent the chatbot response 404 from being delivered to the first user. In such embodiments, security control module 216 may generate a modified response 256 for the end user indicating the requested information cannot be provided, without revealing the specific classified content that was originally generated by the AI model 182. In some embodiments, the second user may additionally or alternatively flag the interaction for security review using controls presented within the security warning notification 410.

At block 320, processing logic provides the modified response to the user-provided data for presentation via the client device associated with the first user. Security control module 216 may transmit the modified response 258 to the client device 102 associated with the first user via network 104, where the modified response 258 is rendered within the conversational interface presented to the first user. The modified response 258 may be transmitted using secure communication protocols to ensure the integrity and confidentiality of the response during transmission. In some embodiments, the modified response 258 may include the original response content with sensitive data items masked, redacted, encrypted, or otherwise modified according to the modification operations performed by the second user, as described above with respect to block 318.

In some embodiments, security control module 216 may cause the modified response 258 to be presented to the first user in a manner that is indistinguishable from unmodified responses 254, such that the first user is not aware that security modifications were applied to the response. In other embodiments, security control module 216 may cause the modified response 258 to include visual indicators or notifications that inform the first user that certain content was modified for security purposes, without revealing the specific nature of the sensitive information that was removed or altered. For example, the modified response 258 may include placeholder text such as "[Content removed for security purposes]" or "[Sensitive information redacted]" in place of the original sensitive content.

In embodiments where the second user selected a blocking operation to prevent the response from being delivered entirely, security control module 216 may generate and transmit a substitute response to the first user indicating that the requested information could not be provided. The substitute response may include a generic message such as "I'm sorry, I cannot provide that information" or may include more specific guidance directing the first user to alternative resources or support channels, depending on organizational policies and the context of the conversation.

FIG. 4D illustrates a security controls interface 140D that enables the second user or a security professional having administrative capabilities to configure the types of sensitive data items that are monitored by security engine 152 and the actions taken when such data items are detected. As illustrated in FIG. 4D, the security controls interface 140D includes multiple sensitivity category toggles 412 organized by data category, such as personally identifiable information and financial information. Each sensitivity category toggle 412 is associated with a specific type of sensitive data, such as tax identification numbers, passport numbers, bank account numbers, credit card numbers, employer identification numbers, or transaction records. For each sensitivity category, the security controls interface 140D presents a detect button 414 and a block button 416 that allow the second user to specify how security engine 152 should respond when the corresponding type of sensitive information is detected. When the detect button 414 is selected for a particular sensitivity category, security engine 152 may detect and display security UI elements alerting the second user to the presence of the sensitive information, while permitting the response to be delivered to the first user without modification. When the block button 416 is selected for a particular sensitivity category, security engine 152 may prevent responses containing the corresponding type of sensitive information from being delivered to the first user until the second user has reviewed and taken appropriate action on the detected content. In some embodiments, the security controls interface 140D may be accessible to security professionals with administrative privileges, enabling such users to configure organization-wide security policies that govern how different types of sensitive information are handled across conversational interactions. The configuration settings specified via the security controls interface 140D may be stored and applied to subsequent interactions, allowing security engine 152 to automatically enforce the configured detection and blocking behaviors without requiring the second user to manually configure settings for each individual conversation.

It should be noted that UIs 140 illustrated with respect to FIGS. 4A-4D are provided for the purpose of example and illustration only and are not intended to be limiting. Each of UIs 140 may have additional or alternative elements and may be presented in accordance with an alternative design.

In some embodiments, security log module 218 of security engine 152 may maintain comprehensive records of security events (e.g., security logs 260) that occur during conversational interactions, including detection events, modification operations, and security professional decisions. A security log 260 may include entries that capture the nature of detected sensitive information, the context in which the detection occurred, the identity of the first user who provided the data or received the response, the identity of the second user who reviewed and acted upon the detected content, and/or the specific actions taken in response to the detection. Security log module 218 may structure the log entries to facilitate subsequent analysis and reporting while preserving user privacy by storing metadata about security events rather than the sensitive content itself in some cases. For example, security log 260 may include metadata such as timestamps indicating when sensitive data items were detected, identifiers of the data sensitivity categories that were triggered (e.g., personally identifiable information, financial information, health information, etc.), confidence scores associated with the sensitivity determinations, identifiers of the detection techniques that identified the sensitive content (e.g., pattern matching, AI model inference, etc.), identifiers of the modification operations that were applied to the detected content, and so forth. Security log module 218 may additionally store contextual metadata such as session identifiers, conversation thread identifiers, application identifiers, and/or user role designations that enable correlation of security events across related interactions without requiring storage of the actual user-provided data 252 or generated response content 254. In some embodiments, security log module 218 may implement data minimization techniques that aggregate or anonymize certain log attributes to further reduce privacy risks while maintaining sufficient granularity for compliance and audit purposes. For example, security log module 218 may store hashed or tokenized representations of user identifiers rather than actual user identifiers, enabling tracking of security event patterns associated with particular users without directly linking log entries to identifiable individuals. Security log module 218 may also implement configurable retention policies that automatically purge or archive log entries after specified time periods, balancing historical analysis against privacy considerations and storage constraints. In embodiments where regulatory conditions mandate retention of more detailed information, security log module 218 may store encrypted representations of sensitive content that can only be accessed by authorized personnel with appropriate decryption credentials, ensuring that detailed audit trails are available while limiting routine access to privacy-preserving metadata representations.

In some embodiments, security engine 152 may analyze a security log 260 to identify patterns in security events associated with particular end users or particular types of data. For example, security log module 218 may track the frequency with which a particular end user provides data that triggers security detections, the types of sensitive information that are repeatedly detected in interactions involving a particular end user, and the outcomes of security professional reviews for interactions associated with that end user. Based on this analysis, security engine 152 may determine that a particular end user presents an elevated security risk based on a pattern of behavior observed in previously received user-provided data.

Responsive to determining that a particular end user presents an elevated security risk, security engine 152 may take one or more actions with respect to subsequent interactions involving that end user. In some embodiments, security engine 152 may automatically apply more stringent security policies to interactions involving the identified end user, such as prompting security professional review of all responses before delivery rather than only responses containing detected sensitive information. Security engine 152 may additionally or alternatively flag interactions involving the identified end user for priority review by security professionals, ensuring that such interactions receive prompt attention. In some cases, security engine 152 may restrict the end user's access to certain features or functionalities of the conversational application based on the detected security risk, or may block the end user from interacting with the application entirely pending further review.

Similarly, security engine 152 may analyze a security log 260 to identify patterns associated with particular types of data or particular categories of sensitive information. For example, security log module 218 may track the frequency with which particular types of sensitive information are detected across all interactions, the contexts in which particular types of sensitive information are most commonly encountered, and the modification operations that are most frequently applied to particular types of sensitive information. Based on this analysis, security engine 152 may determine that a particular type of data presents an elevated security risk based on patterns observed in previously received user-provided data or previously generated responses.

Responsive to determining that a particular type of data presents an elevated security risk, security engine 152 may adjust the security policies applied to that type of data. In some embodiments, security engine 152 may automatically transition a sensitivity category from a detect mode to a block mode based on the frequency or severity of security events associated with that category. Security engine 152 may additionally or alternatively adjust the confidence thresholds used by data sensitivity module 212 when classifying data items of the identified type, lowering the threshold to increase detection sensitivity for data types that have been associated with security incidents. In some cases, security engine 152 may generate alerts or notifications for security professionals indicating that a particular type of data has been associated with an elevated number of security events, enabling the security professionals to review and adjust security policies as appropriate.

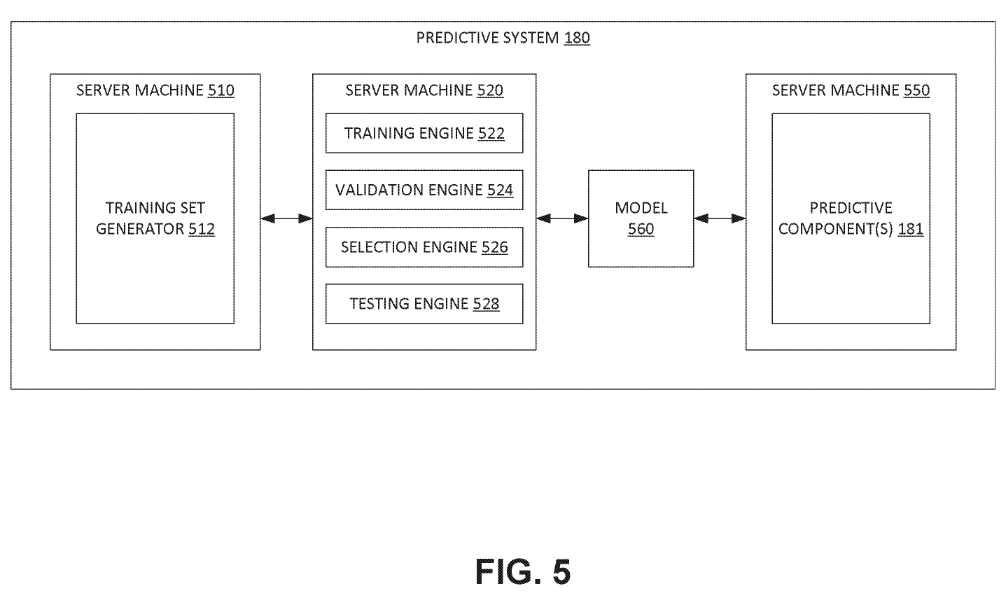

FIG. 5 illustrates an example predictive system, in accordance with implementations of the present disclosure. As illustrated in FIG. 5, predictive system 180 can include a training set generator 512 (e.g., residing at server machine 510), a training engine 512, a validation engine 524, a selection 526, and/or a testing engine 528 (e.g., each residing at server machine 520), and/or a predictive component 552 (e.g., residing at server machine 550). Training set generator 512 may be capable of generating training data (e.g., a set of training inputs and a set of target outputs) to train one or more AI model 560.

In some embodiments, one or more of AI model(s) 560 (e.g., AI model 182) can include a general purpose model that is trained to perform a wide variety of tasks. In such embodiments, training set generator 512 can generate a training data set for training AI model 182 based on a corpus of textual data, audio data, video data, and so forth. The corpus can include a wide array of information gathered from numerous sources, including publicly available web pages (e.g., blogs, forums, news sites, academic papers, online encyclopedias, etc.), books and literature, social media, research papers, public datasets, and so forth. Training set generator 512 can extract features from data of the corpus and can transform the extracted features into a format that the AI model 182 can interpret. In some embodiments, training set generator 512 can perform one or more tokenization operations (e.g., to break down the textual data, audio data, video data, etc. into smaller units called tokens), one or more normalization operations (e.g., to convert the tokens into a common format and/or a format that can be handled by the AI model 182), one or more noise removal operations (e.g., to remove or filter out unwanted data or metadata), and/or one or more data formatting operations (e.g., to structure the tokens uniformly and indicate contextual windows between tokens indicating dependencies between tokens). In some embodiments, training set generator 512 can obtain annotation data for the tokens obtained based on the data of the corpus. Annotation data can include an indication of a classification associated with the token. In some embodiments, the annotation data can be provided by human annotators or according to other annotation techniques. Training set generator 512 can update the training data set to include the extracted features, the generated tokens, and/or the annotation data. As described below, training engine 522 can use the training data to perform the wide range of tasks.

Training engine 522 can train an AI model 560 using the training data from training set generator 512, as described above. The model 560 can refer to the model artifact that is created by the training engine 522 using the training data that includes training inputs and/or corresponding target outputs (correct answers for respective training inputs). The training engine 522 can find patterns in the training data that map the training input to the target output (the answer to be predicted), and provide the model 560 that captures these patterns. The model 560 can be composed of, e.g., a single level of linear or non-linear operations (e.g., a support vector machine (SVM or may be a deep network, i.e., a machine learning model that is composed of multiple levels of non-linear operations). An example of a deep network is a neural network with one or more hidden layers, and such a machine learning model may be trained by, for example, adjusting weights of a neural network in accordance with a backpropagation learning algorithm or the like.

In some embodiments, training engine 522 can first pre-train the AI model 560 on a corpus of text (e.g., generated by or accessible to training set generator 512 and/or training engine 522) to create a foundational model, and afterwards fine-tuned on more data pertaining to a particular set of tasks to create a more task-specific, or targeted, model. The foundational model can first be pre-trained using a corpus of text that can include text context in the public domain, licensed content, and/or proprietary content. Such a pre-training can be used by the model to learn broad language elements including general sentence structure, common phrases, vocabulary, natural language structure, and any other elements commonly associated with natural language in a large corpus of text. In some embodiments, this first, foundational model can be trained using self-supervision, or unsupervised training on such datasets.

In some embodiments, the AI model 560 can then be further trained and/or fine-tuned on organizational data, including proprietary organizational data. The AI model 560 can also be further trained and/or fine-tuned on organizational data associated with a virtual meeting 160 and/or other documents, including proprietary organizational data associated with a virtual meeting 160 and/or other documents.

In some embodiments, the second portion of training, including fine-tuning, may be unsupervised, supervised, reinforced, or any other type of training. In some embodiments, this second portion of training may include some elements of supervision, including learning techniques incorporating human or machine-generated feedback, undergoing training according to a set of guidelines, or training on a previously labeled set of data, etc. In a non-limiting example associated with reinforcement learning, the outputs of the AI model 560 while training may be ranked by a user, according to a variety of factors, including accuracy, helpfulness, veracity, acceptability, or any other metric useful in the fine-tuning portion of training. In this manner, the AI model 560 can learn to favor these and any other factors relevant to users within an organization, or associated with a virtual meeting, when generating a response. In such a way, a foundational model can be further trained to perform within a virtual meeting, and provide useful information, as well as help to accomplish useful tasks associated with the virtual meeting.

In some embodiments, the AI model 560 may include one or more pre-trained models, or fine-tuned models. In a non-limiting example, in some embodiments, the goal of the “fine-tuning” may be accomplished with a second, or third, or any number of additional models. For example, the outputs of the pre-trained model may be input into a second AI model that has been trained in a similar manner as the “fine-tuned” portion of training above. In such a way, two more AI models may accomplish work similar to one model that has been pre-trained, and then fine-tuned.

In one embodiment, the AI model 560 may be one or more of decision trees, random forests, support vector machines, or other types of machine learning models. In one embodiment, the AI model 560 may be one or more artificial neural networks (also referred to simply as a neural network). The artificial neural network may be, for example, a convolutional neural network (CNN) or a deep neural network. In one embodiment, processing logic performs supervised machine learning to train the neural network.

Artificial neural networks generally include a feature representation component with a classifier or regression layers that map features to a target output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). The neural network may be a deep network with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. Neural networks may learn in a supervised (e.g., classification) and/or unsupervised (e.g., pattern analysis) manner. Some neural networks (e.g., such as deep neural networks) include a hierarchy of layers, where the different layers learn different levels of representations that correspond to different levels of abstraction. In deep learning, each level learns to transform its input data into a slightly more abstract and composite representation.

In some embodiments, the AI model 560 may be one or more recurrent neural networks (RNNs). An RNN is a type of neural network that includes a memory to enable the neural network to capture temporal dependencies. An RNN is able to learn input-output mappings that depend on both a current input and past inputs. The RNN will address past and future measurements and make predictions based on this continuous measurement information. One type of RNN that may be used is a long short term memory (LSTM) neural network.

As indicated above, the AI model 560 may be one or more generative AI models, allowing for the generation of new and original content. The generative AI model can use other machine learning models including an encoder-decoder architecture including one or more self-attention mechanisms, and one or more feed-forward mechanisms. In some embodiments, the generative AI model can include an encoder that can encode input textual data into a vector space representation; and a decoder that can reconstruct the data from the vector space, generating outputs with increased novelty and uniqueness. The self-attention mechanism can compute the importance of phrases or words within a text data with respect to all of the text data. A generative AI model can also utilize the previously discussed deep learning techniques, including recurrent neural networks (RNNs), convolutional neural networks (CNNs), or transformer networks.

In some embodiments, the AI model 560 may be one or more transformer-based models. Transformer models utilize self-attention mechanisms to process input sequences in parallel rather than sequentially, enabling the model to capture long-range dependencies within the input data. Transformer architectures may include an encoder portion that processes input sequences and generates contextual representations, a decoder portion that generates output sequences based on the encoded representations, or both encoder and decoder portions operating together. Training data for transformer models may include large-scale text corpora, parallel text datasets for translation tasks, question-answer pairs, dialogue transcripts, and other sequential data that captures relationships between input and output sequences.

In some embodiments, the AI model 560 may be one or more ensemble models that combine predictions from multiple base models to produce a final output. Ensemble techniques may include bagging, where multiple models are trained on different subsets of the training data and their predictions are aggregated, boosting, where models are trained sequentially with each subsequent model focusing on correcting errors made by previous models, or stacking, where outputs from multiple base models are used as inputs to a meta-model that produces the final prediction. Training data for ensemble models may include the same data used for individual base models, with variations in sampling or weighting applied to create diversity among the ensemble members.

In some embodiments, the AI model 560 may be one or more classification models trained to categorize input data into predefined classes or categories. Classification models may be trained using labeled datasets where each training example is associated with a class label indicating the correct category. Training data for classification models used in security contexts may include examples of sensitive data items labeled with their corresponding sensitivity categories, examples of benign data items labeled as non-sensitive, and examples of various attack patterns labeled with their corresponding threat classifications.

In some embodiments, the AI model 560 may be one or more sequence-to-sequence models that transform input sequences into output sequences of potentially different lengths. Training data for sequence-to-sequence models may include paired input-output sequences, such as original text paired with summarized versions, queries paired with responses, or unmasked data paired with masked or redacted versions.

Validation engine 524 may be capable of validating a trained model 560 using a corresponding set of features of a validation set from training set generator 512. The validation engine 524 may determine an accuracy of each of the trained models 560 based on the corresponding sets of features of the validation set. The validation engine 524 may discard a trained model 560 that has an accuracy that does not meet a threshold accuracy. In some embodiments, the selection engine 526 may be capable of selecting a trained model 560 that has an accuracy that meets a threshold accuracy. In some embodiments, the selection engine 526 may be capable of selecting the trained model 560 that has the highest accuracy of the trained models 560.

The testing engine 586 may be capable of testing a trained model 560 using a corresponding set of features of a testing set from training set generator 512. For example, a first trained model 560 that was trained using a first set of features of the training set may be tested using the first set of features of the testing set. The testing engine 528 may determine a trained model 560 that has the highest accuracy of all of the trained machine learning models based on the testing sets.

As described herein, predictive component 552 of server may be configured to feed data as input to model 560 and obtain one or more outputs. In some embodiments, predictive component 552 can include or be associated with security engine 152.

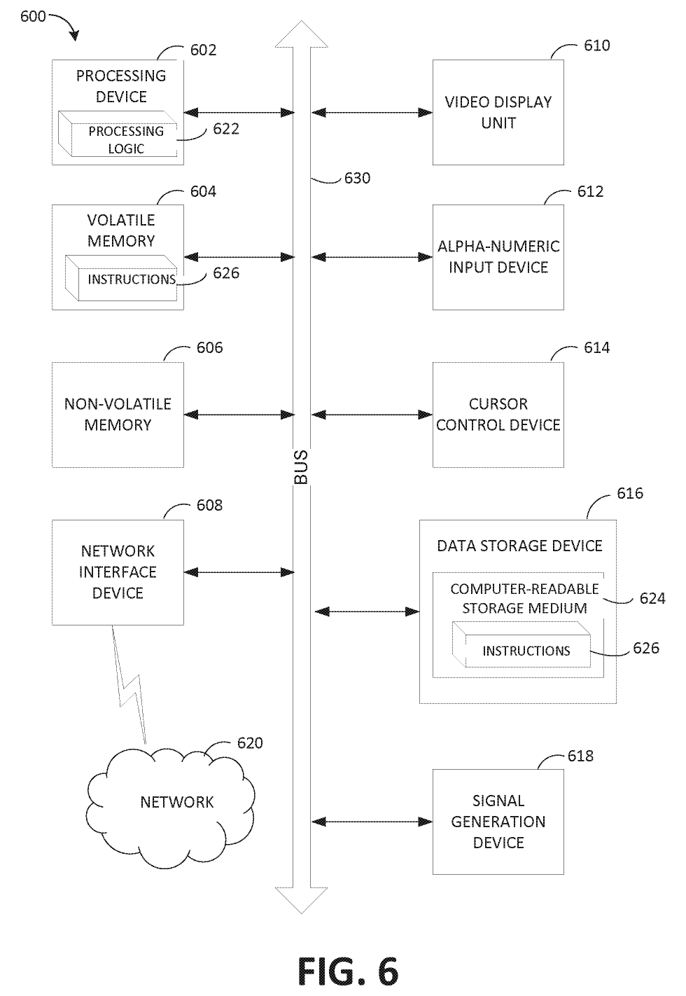

FIG. 6 is a block diagram illustrating an example computer system 600, in accordance with implementations of the present disclosure. The computer system 600 can correspond to computing device(s) 120, predictive system 180, and/or client device 102, described with respect to FIG. 1. Computer system 600 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processing device (processor) 602, a volatile memory 604 (e.g., read-only memory (ROM), flash memory, dynamic random access memory (DRAM) such as synchronous DRAM (SDRAM), double data rate (DDR SDRAM), or DRAM (RDRAM), etc.), a non-volatile memory 606 (e.g., flash memory, static random access memory (SRAM), etc.), and a data storage device 616, which communicate with each other via a bus 630.

Processor (processing device) 602 represents one or more general-purpose processing devices such as a microprocessor, central processing unit, or the like. More particularly, the processor 602 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 can also be one or more special-purpose processing devices such as an application specific integrated circuit (ASIC), a field programmable gate array (FPGA), a digital signal processor (DSP), network processor, or the like. The processor 602 is configured to execute processing logic 622 for performing the operations discussed herein.

The computer system 600 can further include a network interface device 608. The computer system 600 also can include a video display unit 610 (e.g., a liquid crystal display (LCD) or a cathode ray tube (CRT)), an input device 612 (e.g., a keyboard, and alphanumeric keyboard, a motion sensing input device, touch screen), a cursor control device 614 (e.g., a mouse), and a signal generation device 618 (e.g., a speaker).

The data storage device 616 can include a non-transitory machine-readable storage medium 624 (also computer-readable storage medium) on which is stored one or more sets of instructions 626 embodying any one or more of the methodologies or functions described herein. The instructions can also reside, completely or at least partially, within the volatile memory 604 and/or within the processor 602 during execution thereof by the computer system 600, the volatile memory 604 and the processor 602 also constituting machine-readable storage media. The instructions can further be transmitted or received over a network 620 via the network interface device 608.

In one implementation, the instructions 626 include instructions for providing fine-grained version histories of electronic documents at a platform. While the computer-readable storage medium 624 (machine-readable storage medium) is shown in an example implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interactions between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, the use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include the collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
detecting, via a user interface (UI) of a client device, user-provided data at one or more input fields of the user interface of a client device associated with a first user, wherein the one or more input fields are associated with an operation of a computing system that generates a response to the user-provided data;
determining that a data item of at least one of the user-provided data or the generated response satisfies one or more data security criteria;
updating the UI to include one or more security UI elements indicating that the data item satisfies the one or more data security criteria;
responsive to detecting a user interaction with the one or more security UI elements by a second user, modifying the response to the user-provided data; and
providing the modified response to the user-provided data for presentation via the client device associated with the first user.

2. The method of claim 1, wherein determining that the data item satisfies the one or more data security criteria comprises:
determining that a data pattern associated with the data item matches a pre-defined data pattern associated with a sensitive data item.

3. The method of claim 1, wherein determining that the data item satisfies one or more data security criteria comprises:
providing the user-provided data as an input to an artificial intelligence (AI) model trained to predict given data comprises sensitive data items;
obtaining one or more outputs of the AI model, wherein the one or more outputs indicate, for each respective data item of the user-provided data, a level of confidence that the respective data item is a sensitive data item; and
determining that the level of confidence for the data item satisfies one or more confidence criteria.

4. The method of claim 3, wherein the sensitive data item comprises at least one of personally identifiable information, financial information, health information, or user account security information.

5. The method of claim 1, wherein the one or more security UI elements comprise at least one of:
a color-coded tag positioned proximate to the data item in the updated UI, wherein a color of the color-coded tag corresponds to a degree of sensitivity of the data item,
a warning icon positioned adjacent to the data item in the updated UI,
textual content comprising information regarding one or more of a data category associated with the data item or the degree of sensitivity of the data item, or
one or more modification operations that can be performed with respect to the data item.

6. The method of claim 1, wherein modifying the response to the user-provided data to obtain a modified response comprises at least one of:
masking the response,
redacting the response,
deleting the response, or
encrypting the response.

7. The method of claim 1, wherein the one or more data security criteria are defined based on at least one of a user role associated with the first user, an organizational security policy associated with the first user, or a context of a conversation associated with the one or more input fields.

8. The method of claim 1, further comprising:
determining whether a protection setting associated with the client device is set to a first value or a second value, wherein the first value of the protection setting enables the second user to cause unmodified response to be provided for presentation to the first user and a second value of the protection setting prevents the second user from causing the unmodified response to be provided for presentation to the first user; and
responsive to determining that the protection setting is set to the first value, causing the unmodified to be provided for presentation to the first user.

9. The method of claim 8, further comprising:
responsive to determining that the protection setting is set to the second value, causing the UI to be further updated to include a notification that at least one of:
unmodified response is to be modified prior to transmission to the client device associated with the first user,
or the response to user provided data cannot be provided.

10. The method of claim 1, further comprising:
updating a security data structure associated with the client device to indicate at least one of the determination that the data item satisfies the one or more data security criteria or the user interaction with the one or more security UI elements.

11. The method of claim 1, wherein the determination that the data item satisfies the one or more data security criteria is made prior to submission of the data item by the first user for performance of the operation or prior to generation of the response to the user-provided data.

12. A system comprising:
a memory; and
a set of one or more processing devices coupled to the memory, wherein the set of one or more processing devices is to perform operations comprising:
detecting, via a user interface (UI) of a client device, user-provided data at one or more input fields of the user interface of a client device associated with a first user, wherein the one or more input fields are associated with an operation of a computing system that generates a response to the user-provided data;
determining that a data item of at least one of the user-provided data or the generated response satisfies one or more data security criteria;
updating the UI to include one or more security UI elements indicating that the data item satisfies the one or more data security criteria;
responsive to detecting a user interaction with the one or more security UI elements by a second user, modifying the response to the user-provided data; and
providing the modified response to the user-provided data for presentation via the client device associated with the first user.

13. The system of claim 12, wherein determining that the data item satisfies the one or more data security criteria comprises:
determining that a data pattern associated with the data item matches a pre-defined data pattern associated with a sensitive data item.

14. The system of claim 12, wherein determining that the data item satisfies one or more data security criteria comprises:
providing the user-provided data as an input to an artificial intelligence (AI) model trained to predict given data comprises sensitive data items;
obtaining one or more outputs of the AI model, wherein the one or more outputs indicate, for each respective data item of the user-provided data, a level of confidence that the respective data item is a sensitive data item; and
determining that the level of confidence for the data item satisfies one or more confidence criteria.

15. The system of claim 14, wherein the sensitive data item comprises at least one of personally identifiable information, financial information, health information, or user account security information.

16. The system of claim 12, wherein the one or more security UI elements comprise at least one of:
a color-coded tag positioned proximate to the data item in the updated UI, wherein a color of the color-coded tag corresponds to a degree of sensitivity of the data item,
a warning icon positioned adjacent to the data item in the updated UI,
textual content comprising information regarding one or more of a data category associated with the data item or the degree of sensitivity of the data item, or
one or more modification operations that can be performed with respect to the data item.

17. The system of claim 12, wherein modifying the response to the user-provided data to obtain a modified response comprises at least one of:
masking the response,
redacting the response,
deleting the response, or
encrypting the response.

18. The system of claim 12, wherein the one or more data security criteria are defined based on at least one of a user role associated with the first user, an organizational security policy associated with the first user, or a context of a conversation associated with the one or more input fields.

19. The system of claim 12, wherein the operations further comprise:
determining whether a protection setting associated with the client device is set to a first value or a second value, wherein the first value of the protection setting enables the second user to cause unmodified response to be provided for presentation to the first user and a second value of the protection setting prevents the second user from causing the unmodified response to be provided for presentation to the first user; and
responsive to determining that the protection setting is set to the first value, causing the unmodified to be provided for presentation to the first user.

20. A non-transitory computer readable storage medium comprising instructions that, when executed by a processing device, cause the processing device to perform operations comprising:
detecting, via a user interface (UI) of a client device, user-provided data at one or more input fields of the user interface of a client device associated with a first user, wherein the one or more input fields are associated with an operation of a computing system that generates a response to the user-provided data;
determining that a data item of at least one of the user-provided data or the generated response satisfies one or more data security criteria;
updating the UI to include one or more security UI elements indicating that the data item satisfies the one or more data security criteria;
responsive to detecting a user interaction with the one or more security UI elements by a second user, modifying the response to the user-provided data; and
providing the modified response to the user-provided data for presentation via the client device associated with the first user.
